(19) United States
(12) Patent Application Publication
(10) Pub. No.: US 2005/0092348 A1
(43) Pub. Date: May 5, 2005

(54) Method for cleaning an integrated circuit device using an aqueous cleaning composition

(76) Inventors: Ju-Chien Chiang, (US); Ming-Huan Tsai, (US); Huan-Just Lin, Hsin-Chu city (TW); Yuan-Hung Chiu, Taipei (TW); Hun-Jan Tao, Hsinchu (TW)

Correspondence Address: DUANE MORRIS, LLP;IP DEPARTMENT, ONE LIBERTY PLACE, PHILADELPHIA, PA, 19103-7396, US

(21) Appl. No.: 10/701,708

(22) Filed: Nov. 5, 2003

(51) Int. Cl. B08B 3/12

(52) U.S. Cl. 134/1; 134/2; 134/3; 134/41

(57) ABSTRACT

The present invention provides aqueous compositions for cleaning integrated circuit substrates. Specifically, in the cleaning of an integrated circuit substrate, disclosed is a method for removing the by-products of the high-k dielectric dry etch process from the integrated circuit substrate, the method including: contacting the integrated circuit substrate with an aqueous composition including an amount, effective for the purpose of a (a) hydrogen fluoride, followed by (b) a mixture of hydrogen peroxide with a compound selected from the group consisting of ammonium hydroxide, hydrochloric acid and sulfuric acid.

### FIELD OF THE INVENTION

The present invention generally relates to microelectronic device manufacturing methods, and more particularly to methods of manufacturing semiconductor substrates.

### BACKGROUND OF THE INVENTION

Injection of impurities into microelectronic (e.g., semiconductor) devices is often significant since it typically impacts a number of factors relating to the electrical function of the device, production yield, quality, and the like. Subsequent to impurity injection, the formation of device elements typically involves the use of deposited films or insulating films in connection with circuit distribution. In general, the manufacture of microelectronic devices often involves a number of steps, including photolithographic process steps for transferring a mask having a predetermined pattern onto a wafer surface, oxidation process steps, impurity doping process steps, metallization process steps, and related process steps.

As a result of these processes, contaminants often accumulate on the devices. As an example, the devices may be sensitive to extremely low levels of contaminants such as those present on the order of 12 parts per million. Additionally, patterns in the devices may be adversely affected by the contaminants, such as those which are 12 micrometers or less in diameter. Thus, close monitoring of the processes involved in manufacturing the devices may be desirable.

Wafer cleaning processes typically serve an important role in controlling contaminant levels in microelectronic devices. Device cleaning is often required after various individual processes are carried out such as, for example, oxidation, photolithography, diffusion, ion injection, epitaxial film formation using a CVD (Chemical Vapor Deposition) method, metallic processes, and the like. Conventional cleaning processes typically fall into two categories: chemical methods and physical methods. Chemical methods usually encompass using deionized water, acid or alkali etching, oxidation/reduction using corresponding agents, plasma carbonization of organic material, decomposition using organic cleaners, and the like. Physical methods typically encompass utilizing organic cleaners or ultrasonic waves on the wafers, grinding the wafers to attempt to remove particles which may be present on the wafers, brushing the wafers to potentially remove any deposited particles, and spraying the wafers with a high pressure medium such as deionized water, gas, or the like. These techniques are known to one who is skilled in the art.

A common method used in cleaning of microelectronic devices typically involves removing impurities on a wafer surface using a standard cleaning solution, rinsing the wafer using deionized water, contacting the wafer surface with a dilute hydrogen fluoride solution to remove oxidation films and metallic contaminants, rerinsing the wafer using deionized water, and finally spin drying the wafer. A standard solution usually contains a mixture of ammonium hydroxide, hydrogen peroxide, and deionized water which is intended to clean and remove: (1) inorganic contaminants such as dust, (2) organic components, and (3) thin oxidized films which may be present on the wafer surface. Other contaminants such as metallic contaminants can be removed from the wafer surface using dilute hydrogen fluoride.

The above cleaning method suffers from potential drawbacks. Specifically, it may be difficult to completely remove contaminants of elements having high oxidation numbers, such as copper, for example, along with organic contaminants by only using the cleaning solution by itself. Moreover, erosion of the wafer surface may occur as a result of this cleaning method, with the surface having an undesirable μ-roughness.

There is a need in the art for cleaning compositions and methods of using the same which potentially remove organic contaminants, along with metallic contaminants having a higher oxidation-reduction potential than hydrogen. It would be particularly desirable if the cleaning compositions resulted in minimal wafer surface erosion when contacted by the compositions. In particular, there is a need in the art for removing the by-products of the high-k dielectric dry etch process, i.e., the post-etch polymer, from an integrated circuit substrate.

### SUMMARY OF THE INVENTION

The present invention provides aqueous compositions for cleaning integrated circuit substrates. Specifically, in the cleaning of an integrated circuit substrate, disclosed is a method for removing the by-products of the high-k dielectric dry etch process from the integrated circuit substrate, the method comprising: contacting the integrated circuit substrate with an aqueous composition comprising an amount, effective for the purpose of (a) hydrogen fluoride, (with optional aqueous rinse) followed by (b) a mixture of hydrogen peroxide with a compound selected from the group consisting of ammonium hydroxide, hydrochloric acid and sulfuric acid.

Alternatively, the present invention relates to a method for removing the by-products of the high-k dielectric dry etch process from the integrated circuit substrate, said method comprising: contacting the integrated circuit substrate with an aqueous composition comprising an amount, effective for the purpose of (a) hydrogen fluoride, followed by (b) a mixture of hydrogen peroxide and ammonium hydroxide.

The invention also provides methods for cleaning integrated circuit substrates used in microelectronic devices. The methods comprise contacting the substrates with the aqueous compositions of the invention.

The invention is potentially advantageous in that it may offer more efficient cleaning of wafer surfaces relative to conventional cleaning techniques. In addition, the wafer surfaces may experience less corrosion in comparison to the conventional techniques.

### DESCRIPTION OF THE PREFERRED EMBODIMENTS

The present invention now will be described more fully hereinafter with reference to the preferred embodiments of the invention. This invention may, however, be embodied in many different forms and should not be construed as limited to the embodiments set forth herein. Rather, these embodiments are provided so that this disclosure will be thorough and complete, and will fully convey the scope of the invention to those skilled in the art.

In one aspect, the invention relates to aqueous compositions for removing the by-products of the high-k dielectric dry etch process (e.g., Group IVB transition metals; Ti, Zr, Hf) in the cleaning of integrated circuit substrates (e.g., wafers). The aqueous compositions comprise from about 0.05 to about 30 percent of hydrogen fluoride based on the volumes of the compositions, from about 0.05 to about 30 percent of ammonium hydroxide, or alternatively, hydrochloric or sulfuric acid, based on the volumes of the compositions, and from about 0.05 to about 30 percent of hydrogen peroxide based on the volumes of the compositions. The high-k dielectric is typically an oxide or silicate of Hf or Zr. The k value of the dielectric is generally greater than 10. A combination of deionized water and ozone (ozone concentration greater than 20 ppm in deionized water) is preferred when an aqueous rinse is employed.

In forming the aqueous compositions of the invention, it is preferred to employ solutions which are 45-55 weight percent concentration hydrogen fluoride since they are widely available commercially. Although not being bound to any theory, it is believed that the hydrogen fluoride potentially functions to remove oxidized materials on the wafer surfaces, reduce the adhesion of impurities thereon, and improve wafer surface passivation. It is also preferred to employ solutions containing 25-35 weight percent concentration hydrogen peroxide solutions to potentially maximize the removal efficiency of metals such as copper. Although not intending to be bound by any one theory, the oxidizing power of the hydrogen peroxide may be attributable to the presence of nascent oxygen which is typically generated after the decomposition of the hydrogen peroxide.

The cleaning of the integrated circuit substrate preferably comprises contacting the integrated circuit substrate with the aqueous cleaning composition at a temperature from about 15° C. to about 90° C., and for a time of from about 10 seconds to about 10 minutes. The method of the present invention may further comprise megasonic physical cleaning.

Preferred combinations of treatment materials are as follows: (1) Hydrogen fluoride (HF) treatment/deionized water (DIW) rinse/ammonium hydroxide-hydrogen peroxide mixture (APM) treatment/DIW rinse; (2) HF treatment/DIW-ozone rinse/APM treatment/DIW rinse; (3) HF treatment/DIW rinse/APM treatment/DIW rinse/hydrochloric acid-hydrogen peroxide mixture (HPM) treatment/DIW rinse; (4) HF treatment/DIW-ozone rinse/APM treatment/DIW rinse/HPM treatment/DIW rinse; or (5) APM treatment/DIW rinse/HPM treatment/DIW rinse.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. In the cleaning of an integrated circuit substrate, a method for removing by-products of a high-k dielectric dry etch process from the integrated circuit substrate, said method comprising:
contacting the integrated circuit substrate with an aqueous composition comprising an amount, effective for the purpose of (a) hydrogen fluoride, followed by (b) a mixture of hydrogen peroxide with a compound selected from the group consisting of ammonium hydroxide, hydrochloric acid and sulfuric acid.

2. The method as recited in claim 1, wherein the aqueous composition comprises from about 0.05 to about 30 percent of hydrogen fluoride based on the volume of the composition.

3. The method as recited in claim 1, wherein the aqueous composition comprises from about 0.05 to about 30 percent of ammonium hydroxide based on the volume of the composition.

4. The method as recited in claim 1, wherein the aqueous composition comprises from about 0.05 to about 30 percent of hydrogen peroxide based on the volume of the composition.

5. The method as recited in claim 1, wherein said cleaning comprises contacting the integrated circuit substrate with the aqueous cleaning composition at a temperature from about 15° C. to about 90° C.

6. The method as recited in claim 1, wherein said cleaning comprises contacting the integrated circuit substrate with the aqueous cleaning composition from about 10 seconds to about 10 minutes.

7. The method as recited in claim 1, wherein said cleaning further comprises megasonic physical cleaning.

8. The method as recited in claim 1, wherein the by-products of the high-k dielectric dry etch process are Group IVB transition metals.

9. The method as recited in claim 1, wherein the dielectric has a k value of greater than about 10.

10. In the cleaning of an integrated circuit substrate, a method for removing by-products of a high-k dielectric dry etch process from the integrated circuit substrate, said method comprising:
contacting the integrated circuit substrate with an aqueous composition comprising an amount, effective for the purpose of (a) hydrogen fluoride, followed by (b) a mixture of hydrogen peroxide and ammonium hydroxide.

11. The method as recited in claim 10, wherein the aqueous composition comprises from about 0.05 to about 30 percent of hydrogen fluoride based on the volume of the composition.

12. The method as recited in claim 10, wherein the aqueous composition comprises from about 0.05 to about 30 percent of ammonium hydroxide based on the volume of the composition.

13. The method as recited in claim 10, wherein the aqueous composition comprises from about 0.05 to about 30 percent of hydrogen peroxide based on the volume of the composition.

14. The method as recited in claim 10, wherein said cleaning comprises contacting the integrated circuit substrate with the aqueous cleaning composition at a temperature from about 15° C. to about 90° C.

15. The method as recited in claim 10, wherein said cleaning comprises contacting the integrated circuit substrate with the aqueous cleaning composition from about 10 seconds to about 10 minutes.

16. The method as recited in claim 10, wherein said cleaning further comprises megasonic physical cleaning.

17. The method as recited in claim 10, wherein the by-products of the high-k dielectric dry etch process are Group IVB transition metals.

18. The method as recited in claim 10, wherein the dielectric has a k value greater than about 10.
